(19) United States
(12) Patent Application Publication
(10) Pub. No.: US 2016/0288700 A1
(43) Pub. Date: Oct. 6, 2016

(54) CONCEALED LUMINOUS AUTOMOBILE RADIATOR COVER

(71) Applicant: SAN YUAN DESIGN CO., LTD., Taoyuan City (TW)

(72) Inventor: Ying-Chung Chen, Taoyuan City (TW)

(21) Appl. No.: 14/695,015

(22) Filed: Apr. 23, 2015

(30) Foreign Application Priority Data
Apr. 1, 2015 (TW) 104204944

(51) Int. Cl. B60Q 1/28; B60Q 1/26

(52) U.S. Cl. CPC B60Q 1/28; B60Q 1/2696; B60Q 1/2623

(57) ABSTRACT

A concealed luminous automobile radiator cover is mounted to a front of an automobile to improve automobile aesthetics and provide a lighting effect of high recognizability to enhance driving security. The radiator cover includes a decoration base that has a front surface in which a light groove is formed. A through hole is formed in an end of the light groove. An LED light bar is received and fixed in the light groove and has a power cable extendable through the through hole to connect to an automobile power supply. A decorative lid made of a light-transmittable material is attached to and covers an outside surface of the decoration base. The decorative lid has a surface on which a sputter-coated film is formed through sputter coating to exhibit an electroplating like mirror surface that allows light emitting from the LED light to transmit therethrough for outward projection to exhibit lighting.

### TECHNICAL FIELD OF THE INVENTION

The present invention relates generally to a design of a concealed luminous automobile radiator cover, and more particularly to a newfangled radiator cover structure, which shows, on an outside appearance thereof, an electroplating like effect exhibiting a sense of high quality and aesthetics and allows light from an interior light source to transmit through a sputter-coated film formed through unique processing to show a lighting effect so as to feature technology, fashion, and security, for be particularly applicable to transportation devices, such as automobiles, motorcycles, electrical vehicles, or the likes.

### DESCRIPTION OF THE PRIOR ART

Automobiles are often provided with a radiator grille having a grating structure or the likes in front of an engine bay. This arrangement is provided generally for protection of a radiator in the interior and also guiding a great mass of air into the interior of the engine bay so that through air convection, the radiator may helps reduce the temperature of an engine. Besides improving the performance of automobiles, the recent vivid and prosperous development of the automobile industry also places attention on the integration and unity of the entirety of the outside appearance. The radiator griller is, generally speaking, set on the front part of an automobile and is often arranged to carry and be combined with a mark of the automobile manufacturer, making it the most attractive part of the entirety of the outside appearance of an automobile. Most of the automobile manufacturers may decorate the radiator grille, which is generally a structure of black grating, with electroplating decorative strips in order to upgrade the sense of design in the entirety thereof.

Automobile owners may also wish to use a radiator grille that includes light-emitting diode (LED) lights thereon for improving the sense of fashion and technology. However, the LED lights are directly exposed outside a surface of the radiator grille, making it lack the sense of beauty. In addition, the light is directly projected outward as intense light that might irritate the eyes of other drivers or pedestrians, leading to an adverse effect and indirectly affecting driving security.

In view of this, the present invention is made for overcoming such shortcoming by providing a concealed luminous automobile radiator grille, which casts an electroplating visual effect on an outside appearance of the radiator grille to exhibit a sense of high quality and also allows for emission of soft interior lighting to feature both visual and alarming effects, while totally free of negative influence of driving security.

### SUMMARY OF THE INVENTION

The primary object of the present invention is to provide a concealed luminous automobile radiator cover, which through surface treatment achieved with unique processing conceals a light bar in the interior so that the radiator cover, in a normal condition, exhibits an electroplating like effect that provides a sense of a delicate mirror surface and, when energized, allows light emitting from the light bar to transmit through the uniquely processed sputter-coated film for outward projection to provide a special light-transmitting effect of a luminous radiator cover, thereby increasing recognizability of an automobile in movement by providing a unique automobile-front day-lighting effect and also achieving a unique visual perception effect featuring senses of both technology and fashion.

To achieve the above object, the present invention provides a concealed luminous automobile radiator cover, which mainly comprises a decoration base, a light-emitting diode (LED) light bar, and a decorative lid, wherein the decoration base is designed to match an overall configuration of an automobile and is attached to a radiator grille. The decoration base has a front surface in which a light groove is formed. A through hole is formed in an end of the light groove. The LED light bar has backside adhesive for direct and adhesive attachment in the light groove of the decoration base. The light bar has a power cable extendable through the through hole of the decoration base to the back side for connection with an automobile power supply. The decorative lid is made of a light-transmittable material and has an outside surface on which a sputter-coated film is formed through sputter coating and is attachable to and covers an outside surface of the decoration base so as to conceal the light bar in the interior in a normal condition and to provide an electroplating like effect showing a sense of a delicate mirror surface.

Further, when the light bar is energized and gives off light, the light is allowed to project outward by transmitting through the sputter-coated film for exhibiting a luminous effect so as to provide a decorative radiator cover structure that features both sense of quality and visual effect.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view showing the present invention.

FIG. 2 is a perspective view of the present invention.

FIG. 3 is a perspective view, in an enlarged form, showing a portion of the present invention.

FIG. 4 is a schematic view illustrating an example of application of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

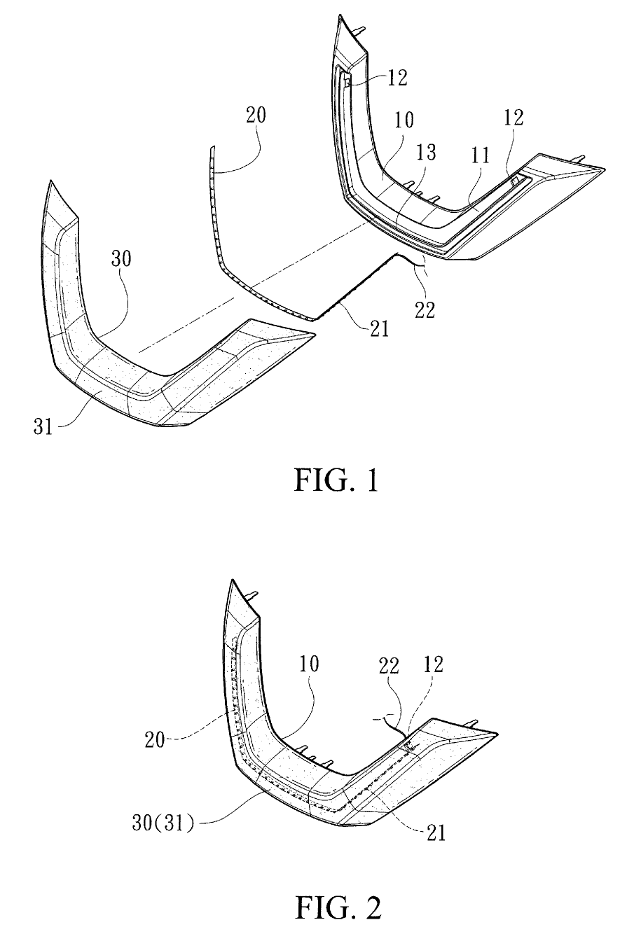

The present invention provides a concealed luminous automobile radiator cover, of which an embodiment, as shown in FIGS. 1-3, mainly comprises a decoration base 10, a light-emitting diode (LED) light bar 20, and a decorative lid 30, wherein the decoration base 10 has an outside configuration that is made to match an overall configuration of a specific mode of automobile to which it is applicable. In the instant embodiment, the decoration base 10 is of a configuration design that shows a substantially U-shaped three-dimensional outside configuration and the decoration base 10 has a front surface in which a U-shaped light groove 11 is formed to extend along an inner edge of the U-shaped configuration of the base and also comprises a through hole 12 formed therein at each of ends of the light groove 11 and a rib 13 mounted in the interior space of the light groove 11.

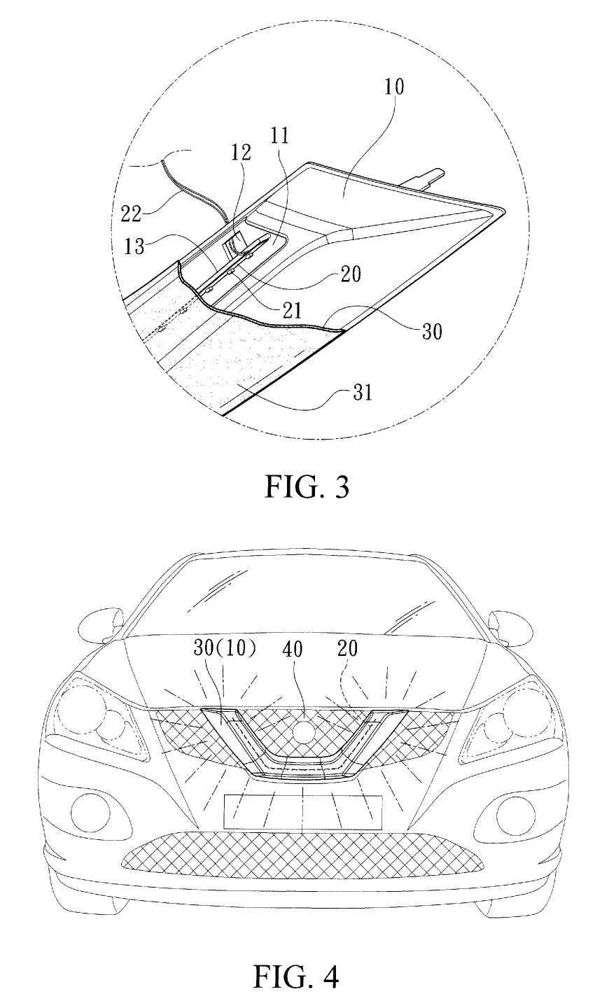

The LED light bar 20, which can be a well-known device, comprises a plurality of LED chips 21 that is electrically connected in series and is connected, at one end thereof; to a power cable 22. The LED chips 21 can be energized by a power supply of the automobile to give off light. Further, in a preferred embodiment, the LED light bar 20 is provided, on a back side thereof, with backing adhesive, which allows the light bar 20 to be directly and adhesively attached to a surface of the rib 13 by following the configuration or shape of the light groove 11 of the decoration base 10. The through holes 12 formed in the ends of the light groove 11 may receive the extension of the power cable 22 therethrough to the back side of the decoration base 10 (as shown in FIG. 3) for connection with the automobile power supply.

The decorative lid 30 is made of a light transmittable material, such as clear acrylic material and polycarbonate (PC). The decorative lid 30 is formed to show a casing or shell configuration that corresponds to and is attachable to and thus covers the outside surface of the decoration base 10. The decorative lid 30 is subjected to sputter coating to form a sputter-coated film 31 on a surface of the casing. The sputter-coated film 31 has a film thickness that is set in a range of 0.1 μm-1 μm. This specific range of film thickness provides the decorative lid 30 with an electroplating like effect that exhibit a sense of high quality while conceals the LED light bar 20 in the interior thereof, but still allows light emitting from the light bar to transmit therethrough for an optimum effect of usage and operation.

Further, in an alternative arrangement, the decoration base 10 may be structured differently by removing the U-shaped light groove 11 and the raised rib 13 therefrom, and instead, a U-shaped light groove and a raised rib are formed on an inside surface of the decorative lid 30 and a through formed is formed in the decoration base 10 for the extension of a power cable, with the LED light bar 20 being disposed in and attached to the light groove and the raised rib of the decorative lid 30, in substantially the same way. In this alternative arrangement, the decorative lid 30 is similarly attached to the decoration base 10 and the same effect of lighting can be achieved. Such a modification or change is well within the scope of the present invention.

Referring to FIGS. 2 and 4, which respectively show an assembled condition and an example of application of the present invention, the present invention comprises a fastening structure, such as attachment pawls and threaded bars, mounted to a back side of the decoration base 10. To mount, the attachment pawls or the threaded bars may be used to securely fix to a radiator grille 40 that is located at the front end of the automobile and the power cable 22 extending to the back side of the decoration base 10 is electrically connected to the automobile power supply to complete the installation or mounting of the present invention.

To use, when the LED light bar 20 is not energized and does not emit light, the sputter-coated film 31 formed on the surface of the decorative lid 30 exhibits an effect of concealing the light bar in the interior so that the outside appearance of the decorative lid 30 of the radiator cover exhibits an complete overall high-quality electroplating-like mirror surface. On the other hand, when the LED light bar 20 is energized, light is emitted from the decorative lid 30 and transmits through the sputter-coated film 31 so that the light emitting from the LED light bar 20 is projected outward to provide a lighting alarm effect having high recognizability and also the light is softened without being projected outwards directly and casting high intensity projection light that may readily cause irritation to the eyes of drivers of automobiles traveling in the opposite direction and those of pedestrians thereby helping greatly improve driving security.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A concealed luminous automobile radiator cover, which comprises a decoration base, a light-emitting diode (LED) light bar, and a decorative lid and is characterized in that
the decoration base has an outside configuration adapted to match an overall configuration of an automobile and is attachable to a grille of the automobile, the decoration base having a front surface in which a light groove is formed, the light groove having an end in which a through hole is formed;
the LED light bar is received and fixed in and extends along the light groove and has an end connected to a power cable, the power cable being extendable through the through hole of the light groove to a back side of the decoration base for connection with a power supply of the automobile; and
the decorative lid comprises a casing made of a light-transmittable material and corresponds, in shape, to the decoration base to be attached to and covers an outside surface of the decoration base, the decorative lid having a surface on which a sputter-coated film is formed through sputter coating to normally exhibit an electroplating like effect showing mirror surface, the sputter-coated film being formed to allow light to transmit therethrough to project outward.

2. The concealed luminous automobile radiator cover according to claim 1, wherein a rib is formed in the light groove of the decoration base and the LED light bar has a back side on which adhesive is applied for direct and adhesive attachment to a surface of the rib.

3. The concealed luminous automobile radiator cover according to claim 1, wherein the sputter-coated film formed on the surface of the decorative lid has a film thickness in the range of 0.1 μm-1 μm.

4. The concealed luminous automobile radiator cover according to claim 1, wherein the decoration base and the decorative lid are coupled with an attachment pawl or a threaded bar.
